(19) United States
(12) Patent Application Publication
(10) Pub. No.: US 2020/0031227 A1
(43) Pub. Date: Jan. 30, 2020

(54) DISPLAY CONTROL APPARATUS AND METHOD FOR CONTROLLING DISPLAY

(71) Applicant: MITSUBISHI ELECTRIC CORPORATION, Tokyo (JP)

(72) Inventors: Hiroshi Irie, Hyogo (JP); Mitsuo Shimotani, Tokyo (JP)

(73) Assignee: MITSUBISHI ELECTRIC CORPORATION, Tokyo (JP)

(21) Appl. No.: 16/481,270

(22) PCT Filed: Mar. 29, 2017
(86) PCT No.: PCT/JP2017/012933

§ 371 Date: Jul. 26, 2019

(51) Int. Cl. B60K 35/00; G06T 11/60; G01C 21/36; G08G 1/16; B60R 1/00

(52) U.S. Cl. CPC B60K 35/00; G06T 11/60; G01C 21/3658; G08G 1/167; B60K 2370/1868; B60R 2300/804; B60R 2300/8086; B60K 2370/1529; B60R 1/00

(57) ABSTRACT

A display control apparatus in the present invention includes the following: a positional-information acquiring unit that acquires positional information about the current position of a subject vehicle; a map-information acquiring unit that acquires, as information about an intersection, map information including information about lanes of all roads connected to the intersection; a lane-restriction determining unit that, based on the positional information and the map information, determines restrictions on the lanes of all the roads connected to the intersection into which the subject vehicle makes an entry; and a display controller that, based on the determination, controls the display of an object indicating whether the subject vehicle can travel after passing through the intersection, the object being displayed with respect to the lanes of all the roads connected to the intersection, except at least the road on which the subject vehicle is located.

### TECHNICAL FIELD

The present invention relates to a display control apparatus that controls the display of information for providing a driver with guidance on an intersection, and to a method for controlling such display.

### BACKGROUND ART

A conventionally disclosed technique is displaying, when a subject vehicle has approached an intersection, whether a road after passing through of the intersection is travelable onto a head-up display (HUD) (c.f., Patent Documents 1 and 2 for instance). Another disclosed technique is identifying and then displaying a lane along which the subject vehicle can travel after passing through an intersection in accordance with a predetermined route (c.f., Patent Document 3 for instance).

### PRIOR ART DOCUMENTS

### Patent Documents

Patent Document 1: Japanese Patent Application Laid-Open No. 7-146154

Patent Document 2: Japanese Patent Application Laid-Open No. 2013-217739

Patent Document 3: Japanese Patent Application Laid-Open No. 2001-272240

### SUMMARY

### Problem to be Solved by the Invention

When roads connected to an intersection have a plurality of lanes, the driver can have difficulty in determining, at first glance, which lane of the road after passing through of the intersection is travelable and which lane is not travelable. In such a case, the techniques in Patent Documents 1 to 3 fail to describe the display of whether the lanes of all the roads connected to the intersection are travelable for the subject vehicle after passing through of the intersection. These techniques hence fail to give sufficient and accurate guidance on the intersection, and thus have room for improvement.

To solve such a problem, it is an object of the present invention to provide a display control apparatus and a method for controlling display that give sufficient and accurate guidance on the intersection, when roads connected to an intersection have a plurality of lanes.

### Means to Solve the Problem

To solve the problem, the present invention provides a display control apparatus. This display control apparatus includes the following: a positional-information acquiring unit that acquires positional information about the current position of a subject vehicle; a map-information acquiring unit that acquires, as information about the intersection, map information including information about lanes of all roads connected to the intersection; a lane-restriction determining unit that, based on the positional information acquired by the positional-information acquiring unit, and the map information acquired by the map-information acquiring unit, determines restrictions on the lanes of all the roads connected to the intersection into which the subject vehicle makes an entry; and a display controller that, based on the determination performed by the lane-restriction determining unit, controls the display of an object indicating whether the subject vehicle is capable of travelling after passing through the intersection, the object being displayed with respect to the lanes of all the roads connected to the intersection, except at least the road on which the subject vehicle is located.

The prevent invention also provides a method for controlling display. The method includes the following: acquiring positional information about the current position of a subject vehicle; acquiring, as information about an intersection, map information including information about lanes of all roads connected to the intersection; based on the acquired positional information and the acquired map information, determining lane restrictions on the lanes of all the roads connected to the intersection into which the subject vehicle makes an entry; and based on the determination, controlling display of whether the subject vehicle is capable of travelling after passing through the intersection, the display being performed with respect to the lanes of all the roads connected to the intersection, except at least the road on which the subject vehicle is located.

### Effects of the Invention

The display control apparatus according to the present invention includes the following: the positional-information acquiring unit that acquires the positional information about the current position of the subject vehicle; the map-information acquiring unit that acquires, as the information about the intersection, the map information including the information about the lanes of all the roads connected to the intersection; the lane-restriction determining unit that, based on the positional information acquired by the positional-information acquiring unit, and the map information acquired by the map-information acquiring unit, determines the restrictions on the lanes of all the roads connected to the intersection into which the subject vehicle makes an entry; and the display controller that, based on the determination performed by the lane-restriction determining unit, controls the display of the object indicating whether the subject vehicle is capable of travelling after passing through the intersection, the object being displayed with respect to the lanes of all the roads connected to the intersection, except at least the road on which the subject vehicle is located. The display control apparatus consequently gives sufficient and accurate guidance on the intersection.

The method for controlling display includes the following: acquiring the positional information about the current position of the subject vehicle; acquiring, as the information about the intersection, the map information including the information about the lanes of all the roads connected to the intersection; based on the acquired positional information and the acquired map information, determining the lane restrictions on the lanes of all the roads connected to the intersection into which the subject vehicle makes an entry; and based on the determination, controlling the display of whether the subject vehicle is capable of travelling after passing through the intersection, the display being performed with respect to the lanes of all the roads connected to the intersection, except at least the road on which the subject vehicle is located. The method consequently gives sufficient and accurate guidance on the intersection.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram illustrating one example of the configuration of a display control apparatus according to a first embodiment of the present invention.

FIG. 2 is a block diagram illustrating one example of the configuration of the display control apparatus according to the first embodiment of the present invention.

FIG. 3 is a block diagram illustrating one example of the hardware configuration of the display control apparatus according to the first embodiment of the present invention.

FIG. 4 is a flowchart illustrating one example of the operation of the display control apparatus according to the first embodiment of the present invention.

FIG. 5 is a diagram for describing the operation of the display control apparatus according to the first embodiment of the present invention.

FIG. 6 is a diagram illustrating one example of display according to the first embodiment of the present invention.

FIG. 7 is a diagram for describing the operation of the display control apparatus according to the first embodiment of the present invention.

FIG. 8 is a diagram illustrating one example of the display according to the first embodiment of the present invention.

FIG. 9 is a diagram for describing the operation of the display control apparatus according to the first embodiment of the present invention.

FIG. 10 is a diagram illustrating one example of the display according to the first embodiment of the present invention.

FIG. 11 is a block diagram illustrating one example of the configuration of a display control apparatus according to a second embodiment of the present invention.

FIG. 12 is a flowchart illustrating one example of the operation of the display control apparatus according to the second embodiment of the present invention.

FIG. 13 is a diagram for describing the operation of the display control apparatus according to the second embodiment of the present invention.

FIG. 14 is a diagram for describing the operation of the display control apparatus according to the second embodiment of the present invention.

FIG. 15 is a diagram illustrating one example of display according to the second embodiment of the present invention.

FIG. 16 is a flowchart illustrating one example of the operation of a display control apparatus according to a third embodiment of the present invention.

FIG. 17 is a diagram for describing the operation of the display control apparatus according to the third embodiment of the present invention.

FIG. 18 is a diagram for describing the operation of the display control apparatus according to the third embodiment of the present invention.

FIG. 19 is a diagram illustrating one example of display according to the third embodiment of the present invention.

FIG. 20 is a flowchart illustrating one example of the operation of a display control apparatus according to a fourth embodiment of the present invention.

FIG. 21 is a diagram for describing the operation of the display control apparatus according to the fourth embodiment of the present invention.

FIG. 22 is a diagram illustrating one example of display according to the fourth embodiment of the present invention.

FIG. 23 is a flowchart illustrating one example of the operation of a display control apparatus according to a fifth embodiment of the present invention.

FIG. 24 is a diagram for describing the operation of the display control apparatus according to the fifth embodiment of the present invention.

FIG. 25 is a diagram illustrating one example of display according to the fifth embodiment of the present invention.

FIG. 26 is a block diagram illustrating one example of the configuration of a display control system according to the embodiment of the present invention.

### DESCRIPTION OF EMBODIMENT(S)

The embodiments of the present invention will be described with reference to the drawings.

### First Embodiment

<Configuration>

The following describes the configuration of a display control apparatus according to a first embodiment of the present invention.

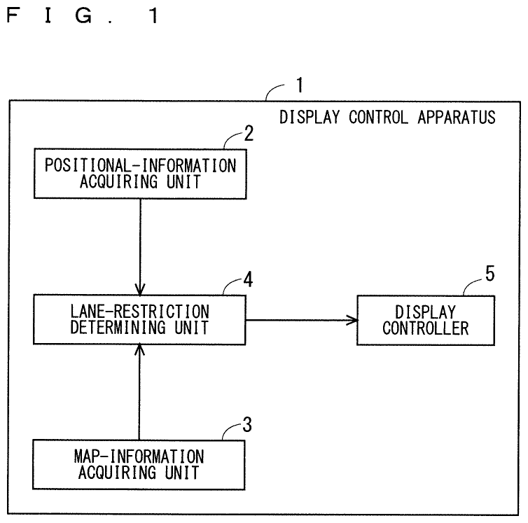

FIG. 1 is a block diagram illustrating one example of the configuration of a display control apparatus 1 according to the first embodiment. FIG. 1 shows minimal components necessary for constituting the display control apparatus according to the present embodiment.

As illustrated in FIG. 1, the display control apparatus 1 includes a positional-information acquiring unit 2, a map-information acquiring unit 3, a lane-restriction determining unit 4, and a display controller 5. The positional-information acquiring unit 2 acquires positional information about the current position of a subject vehicle. The map-information acquiring unit 3 acquires, as information about an intersection, map information including information about lanes of all roads connected to the intersection. Based on the positional information acquired by the positional-information acquiring unit 2, and the map information acquired by the map-information acquiring unit 3, the lane-restriction determining unit 4 determines restrictions on the lanes of all the roads connected to the intersection into which the subject vehicle makes an entry. Based on the determination performed by the lane-restriction determining unit 4, the display controller 5 controls the display of an object indicating whether the subject vehicle can travel after passing through the intersection. This object is displayed with respect to the lanes of all the roads connected to the intersection, except at least the road on which the subject vehicle is located.

The following describes the configuration of another display control apparatus including the display control apparatus 1 in FIG. 1.

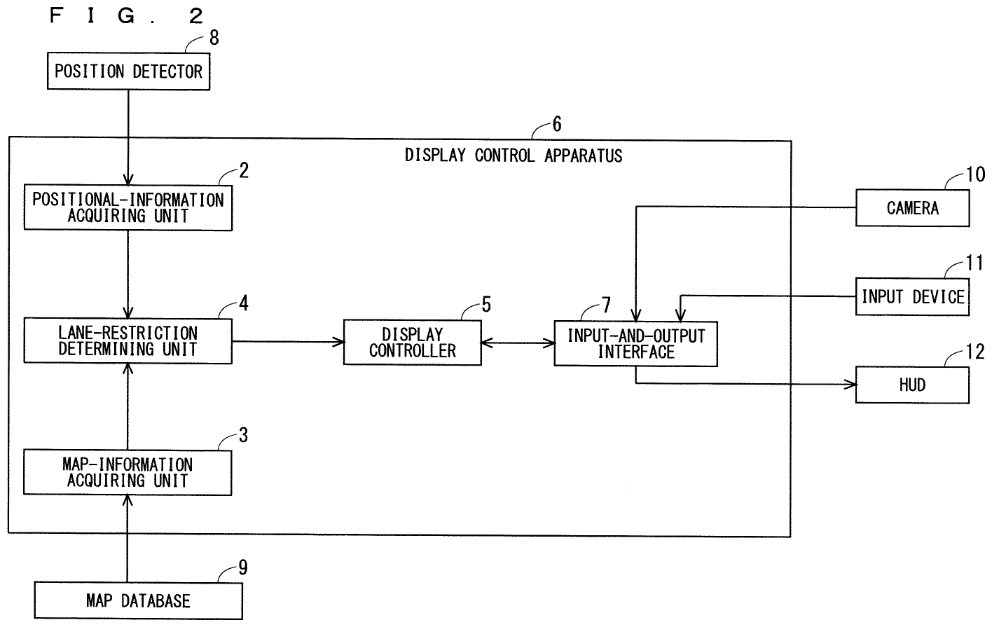

FIG. 2 is a block diagram illustrating one example of the configuration of a display control apparatus 6.

As illustrated in FIG. 2, the display control apparatus 6 includes the positional-information acquiring unit 2, the map-information acquiring unit 3, the lane-restriction determining unit 4, the display controller 5, and an input-and-output interface 7. The positional-information acquiring unit 2 is connected to a position detector 8. The map-information acquiring unit 3 is connected to a map database 9. The input-and-output interface 7 is connected to a camera 10, an input device 11, and a HUD 12.

The positional-information acquiring unit 2 acquires positional information about the current position of the subject vehicle from the position detector 8. The position detector 8 is formed of an antenna that receives a global-positioning-system (GPS) signal, a travel distance sensor, a direction sensor, and other components. The position detector 8 calculates the positional information about the current position of the subject vehicle from various information items detected by these components. The position detector 8 is placed inside the subject vehicle.

The map-information acquiring unit 3 acquires, as information about the intersection, map information including information about the lanes of all the roads connected to an intersection, from the map database 9. The map database 9 is formed of a storage, such as a hard disk drive or a semiconductor memory, and stores the map information. The position detector 9 may be placed inside or outside the subject vehicle. The map data database 9 stores the map information including the information about lanes of all roads connected to the intersection, and stores search information, feature information, and other kinds of information. The information about the lanes includes lane restrictions defined for the individual lanes, such as a right turn only, a left turn only, straight-ahead travel only, and the prohibition of a right turn. The information about the lanes also includes information that relates travelable lanes among the lanes of all the roads connected to the intersection with each other. For instance, a lane capable of a right turn only is related with a travelable lane after passing through of the intersection.

Based on the positional information acquired by the positional-information acquiring unit 2, and the map information acquired by the map-information acquiring unit 3, the lane-restriction determining unit 4 determines restrictions on the lanes of all the roads connected to the intersection into which the subject vehicle makes an entry. To be specific, the lane-restriction determining unit 4 identifies an intersection into which the subject vehicle makes an entry, using the positional information acquired by the positional-information acquiring unit 2, and determines lane restrictions on the lanes of all the roads connected to the intersection.

Based on the determination performed by the lane-restriction determining unit 4, the display controller 5 controls the display of an object indicating whether the subject vehicle can travel after passing through the intersection. The object is displayed with respect to the lanes of all the roads connected to the intersection, except at least the road on which the subject vehicle is located. To be specific, the display controller 5 produces an object indicating whether the subject vehicle can travel after passing through the intersection, and controls the input-and-output interface 7 to display the produced object onto the HUD 12.

The input-and-output interface 7 outputs an image taken by the camera 10, to the display controller 5. The camera 10 is placed in the front of the subject vehicle, and takes an image in front of the subject vehicle including roads. The image taken by the camera 10 corresponds to a view that can be seen by the driver via the windshield. The input-and-output interface 7 outputs information that is input through the input device 11 by a user including the driver, to the display controller 5. The input device 11 may be formed of a touch panel or a hardware key. The input-and-output interface 7 displays the object, produced by the display controller 5, onto the HUD 12.

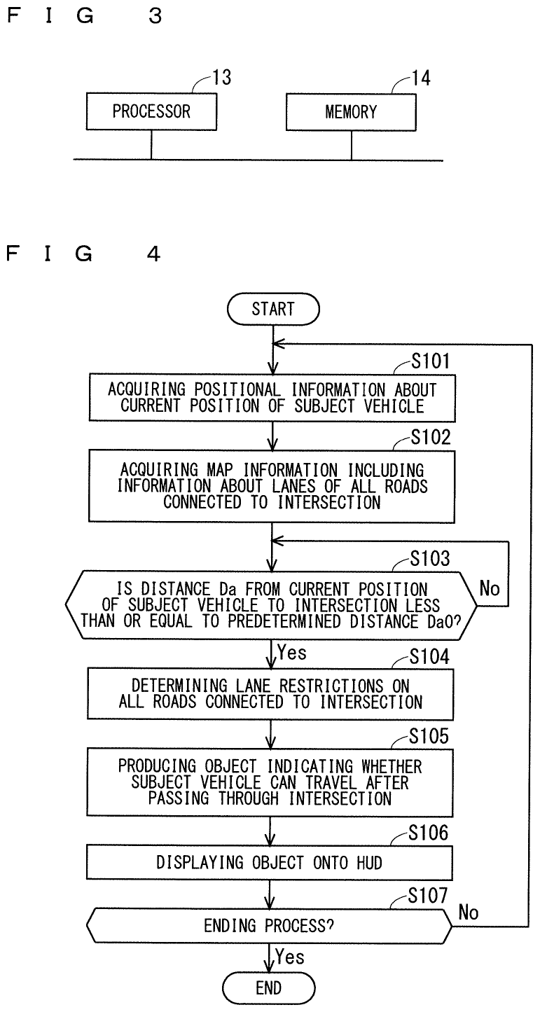

FIG. 3 is a block diagram illustrating one example of the hardware configuration of the display control apparatus 6. The display control apparatus 1 is configured in similar form.

The individual functions of the display control apparatus 6, i.e., the functions of the positional-information acquiring unit 2, the map-information acquiring unit 3, the lane-restriction determining unit 4, the display controller 5, and the input-and-output interface 7, are implemented by a processing circuit. That is, the display control apparatus 6 includes a processing circuit for performing the following functions; acquiring positional information about the current position of a subject vehicle; acquiring, as information about an intersection, map information including information about lanes of all roads connected to the intersection; determining restrictions on the lanes of all the roads connected to the intersection into which the subject vehicle makes an entry; controlling the display of an object indicating whether the subject vehicle is capable of travelling after passing through the intersection, the object being displayed with respect to the lanes of all the roads connected to the intersection, except at least the road on which the subject vehicle is located; and inputting and outputting information to and from an external device. The processing circuit is a processor 13 (e.g., a central processing unit, a processing unit, a calculator, a microprocessor, a microcomputer, a digital signal processor or DSP for short) that executes a program stored in a memory 14.

The individual functions of the display control apparatus 6, i.e., the individual functions of the positional-information acquiring unit 2, the map-information acquiring unit 3, the lane-restriction determining unit 4, the display controller 5, and the input-and-output interface 7, are implemented by software, firmware, or a combination of software and firmware. The software or the firmware is written as a program, and stored in the memory 14. The processing circuit reads and then executes the program, stored in the memory 14, to implement the function of each component. That is, the display control apparatus 6 includes the memory 14 to store a program which, when executed, performs the following process steps: acquiring positional information about the current position of a subject vehicle; acquiring, as information about an intersection, map information including information about lanes of all roads connected to the intersection; determining restrictions on the lanes of all the roads connected to the intersection into which the subject vehicle makes an entry; controlling the display of an object indicating whether the subject vehicle is capable of travelling after passing through the intersection, the object being displayed with respect to the lanes of all the roads connected to the intersection, except at least the road on which the subject vehicle is located; and inputting and outputting information to and from an external device. This program is for a computer to execute the procedure or method of the positional-information acquiring unit 2, the map-information acquiring unit 3, the lane-restriction determining unit 4, the display controller 5, and the input-and-output interface 7. Here, examples of the memory include a non-volatile or volatile semiconductor memory (e.g., a random access memory or RAM for short, a read only memory or ROM for short, a flash memory, an erasable programmable read only memory or EPROM for short, or an electrically erasable programmable read only memory or EEPROM for short), a magnetic disc, a flexible disc, an optical disc, a compact disc, a mini disc, and a DVD. Alternatively, the memory may be any kind of storing medium that will be used in the future.

<Operation>

The following describes the operation of the display control apparatus 6.

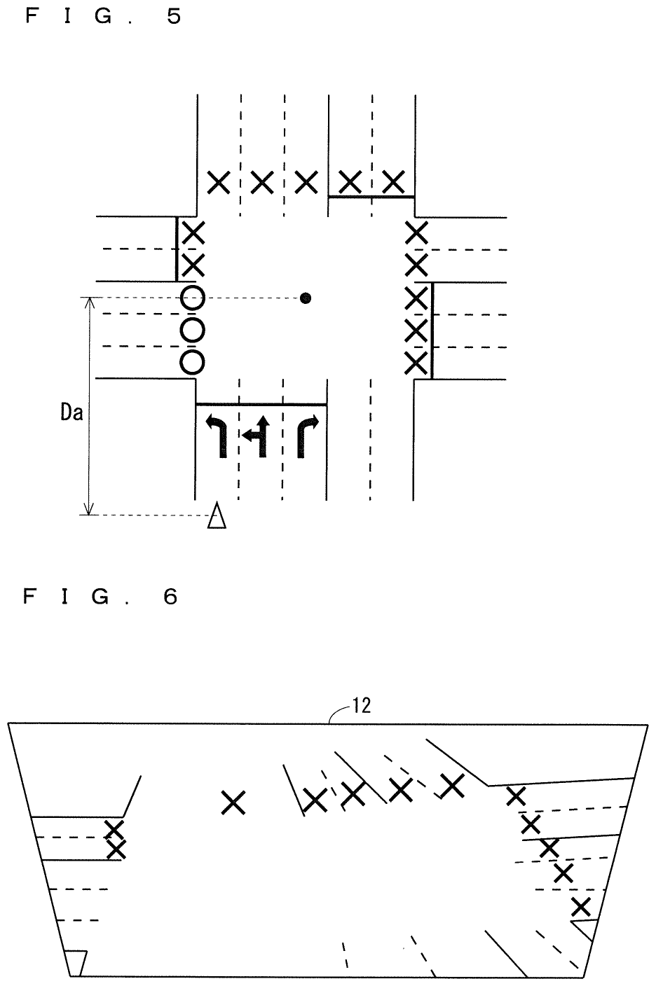

FIG. 4 is a flowchart illustrating one example of the operation of the display control apparatus 6. FIG. 5 is a diagram for describing one example of the operation of the display control apparatus 6. The display control apparatus 6 starts the individual process steps illustrated in FIG. 4, when the engine of the subject vehicle is turned on for instance.

In step S101, the positional-information acquiring unit 2 acquires positional information about the current position of the subject vehicle from the position detector 8.

In step S102, the map-information acquiring unit 3 acquires map information including information about lanes of all roads connected to an intersection.

In step S103, based on the positional information about the current position of the subject vehicle acquired by the positional-information acquiring unit 2, and the map information acquired by the map-information acquiring unit 3, the lane-restriction determining unit 4 calculates a distance Da from the current position of the subject vehicle to the intersection, as illustrated in FIG. 5. FIG. 5 shows a hollow triangle denoting the current position of the subject vehicle, and a black filled-in circle at the intersection denoting the center of the intersection.

The lane-restriction determining unit 4 then determines whether the distance Da is less than or equal to a predetermined distance Da0. If the distance Da is less than or equal to the distance Da0, the process proceeds to step S104. If the distance Da is greater than the distance Da0, the process repeats step S103. It is noted that the user may set the distance Da0 using the input device 11.

In step S104, based on the positional information about the current position of the subject vehicle acquired by the positional-information acquiring unit 2, and the map information acquired by the map-information acquiring unit 3, the lane-restriction determining unit 4 identifies a lane of the road on which the subject vehicle is currently located, and determines lane restrictions on all the roads connected to the intersection into which the subject vehicle makes an entry. To be specific, as illustrated in FIG. 5, the lane-restriction determining unit 4 identifies that the subject vehicle is located on an exclusive left-turn lane. The lane-restriction determining unit 4 then determines travelable and non-travelable lanes after passing through of the intersection, from the lane on which the subject vehicle is currently located. In the example in FIG. 5, lanes with circles indicate travelable lanes, and the lanes with crosses indicate non-travelable lanes.

In step S105, based on the determination performed by the lane-restriction determining unit 4, the display controller 5 produces an object indicating whether the subject vehicle can travel after passing through the intersection. This object is displayed with respect to the lanes of all the roads connected to the intersection, except at least the road on which the subject vehicle is located. To be specific, the display controller 5 uses an image from the camera 10 including the intersection into which the subject vehicle makes an entry, thus producing objects that are displayed through superimposition on positions corresponding to the respective lanes contained in the image.

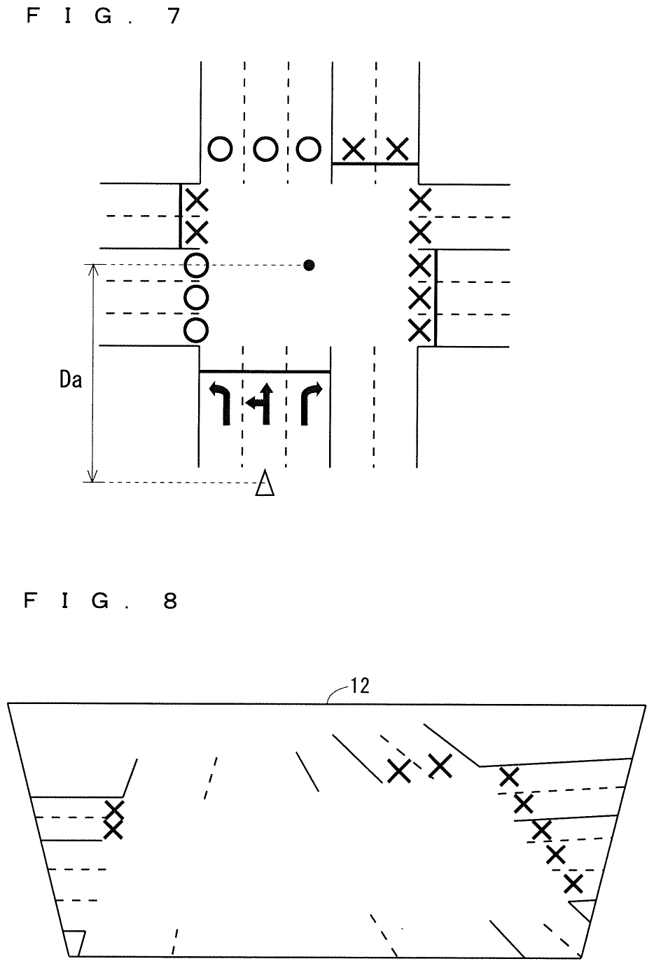

In step S106, the display controller 5 controls the input-and-output interface 7 to display the object, produced in step S15, onto the HUD 12. On the HUD 12, objects with crosses as illustrated in FIG. 6 for instance, are displayed in the positions corresponding to the respective lanes. These objects with the crosses indicate non-travelable lanes.

In step S107, the display control apparatus 6 determines whether to end the individual process steps in FIG. 4. For instance, the display control apparatus 6 determines to end the individual process steps in FIG. 4, when the engine of the subject vehicle is turned off. If the individual process steps in FIG. 4 are determined to end, the process ends. If the individual process steps in FIG. 4 are determined to not end, the process returns to step S101, followed by undergoing each process step, i.e., steps S101 through S107.

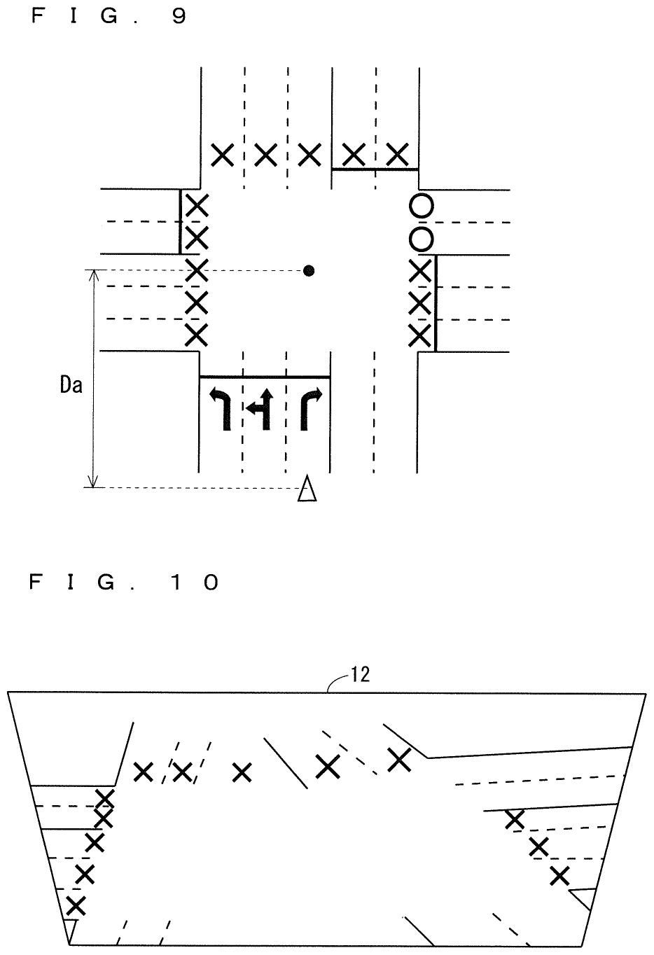

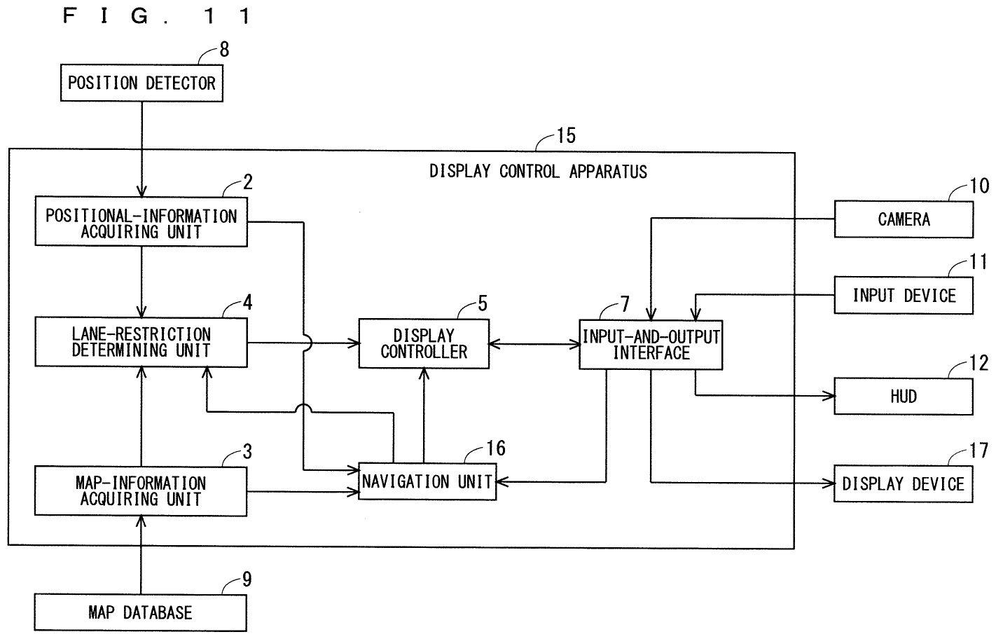

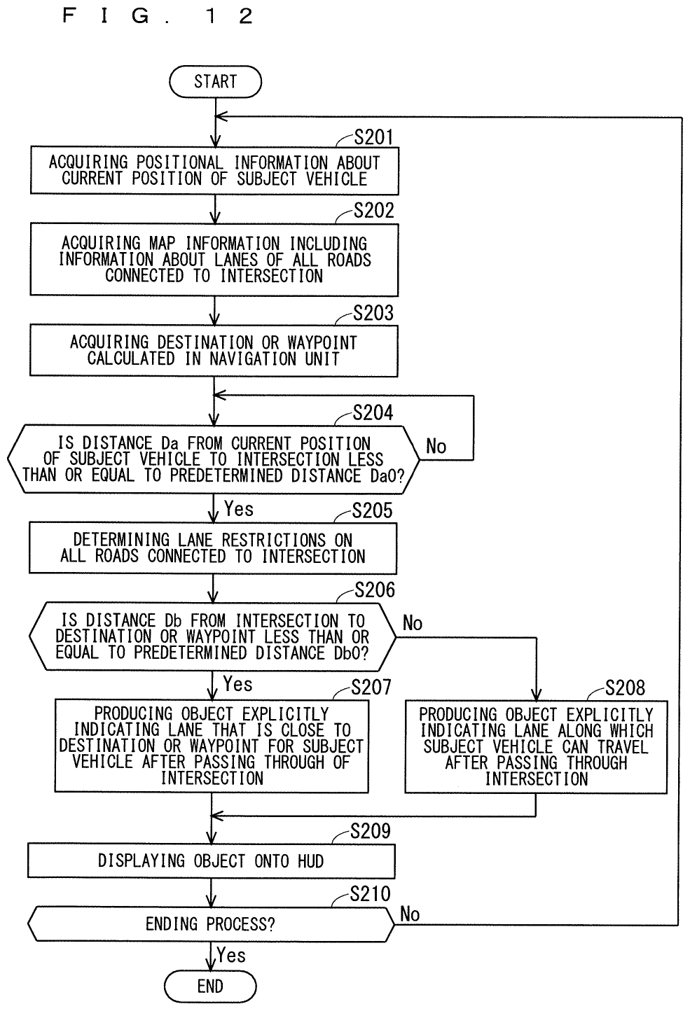

The individual process steps in FIG. 4, although being applied to an instance where the subject vehicle is located on an exclusive left-turn lane, as illustrated in FIG. 5, are also applied to an instance where the subject vehicle is located on another lane. Let the subject vehicle be located on an exclusive lane for left turn and straight-ahead travel, as illustrated in FIG. 7. Accordingly, onto the HUD 12 are displayed objects with crosses as illustrated in FIG. 8. Moreover, let the subject vehicle be located on an exclusive right-turn lane, as illustrated in FIG. 9. Accordingly, on the HUD 12 are displayed objects with crosses as illustrated in FIG. 10.

Although FIGS. 6, 8, and 10 show that only the objects with the crosses are displayed onto the HUD 12, any other thing may be displayed onto the HUD 12. For instance, only objects with circles indicating travelable lanes may be displayed onto the HUD 12 through superimposition on the positions corresponding to the respective lanes. Alternatively, both objects with crosses and objects with circles may be displayed onto the HUD 12 through superimposition on the positions corresponding to the respective lanes.

Although FIGS. 6, 8, and 10 show the objects displayed in the positions corresponding to the respective lanes, what are displayed onto the HUD 12 are not limited to those shown in these drawings. Images as illustrated in FIGS. 5, 7, and 9 for instance, may be displayed in a predetermined region on the HUD 12.

FIGS. 5 to 9 illustrate, but not limited to, an instance where all the roads connected to the intersection each have a plurality of lanes on both sides. For instance, at least one of the roads connected to the intersection may have a single lane on each side.

For an oncoming lane of the road on which the subject vehicle is located, as well, an object may be displayed that indicates whether the subject vehicle can travel after passing through the intersection. For an intersection at which making a U-turn is prohibited, for instance, displayed is an object indicating that the oncoming lane of the road on which the subject vehicle is located is not travelable.

As described above, the display control apparatus according to the first embodiment displays the object indicating whether the subject vehicle can travel after passing through the intersection. This object is displayed with respect to the lanes of all the roads connected to the intersection into which the subject vehicle makes an entry. Consequently, the display control apparatus enables sufficient and accurate guidance on the intersection when the roads connected to the intersection has a plurality of lanes. Further, the object, indicating whether the subject vehicle can travel after passing through the intersection, is displayed on the HUD 12. Such display achieves sufficient and accurate guidance on the intersection with a simple configuration. Still further, the object, indicating whether the subject vehicle can travel after passing through the intersection, is displayed onto the HUD 12. Consequently, with few eye motions, the driver can determine whether the subject vehicle can travel after passing through the intersection.

### Second Embodiment

<Configuration>

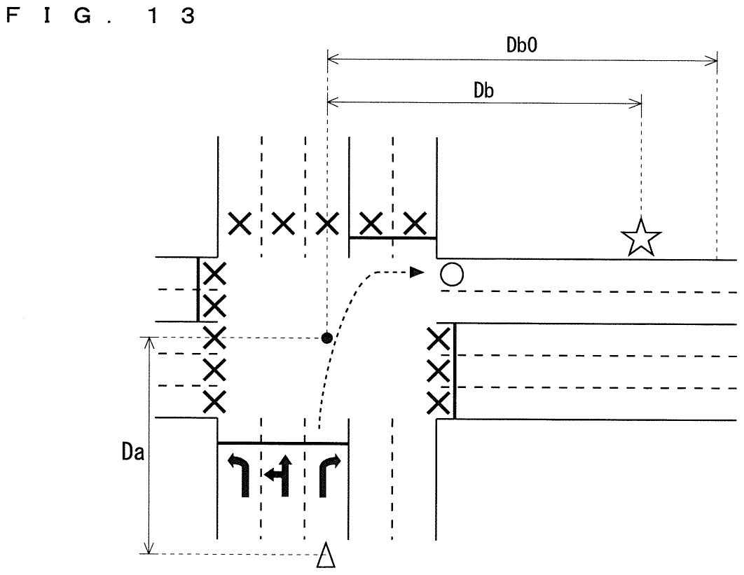

FIG. 11 is a diagram illustrating one example of a display control apparatus 15 according to a second embodiment of the present invention.

As illustrated in FIG. 11, the display control apparatus 15 includes a navigation unit 16. Further, the input-and-output interface 7 is connected to a display device 17. The other configuration and basic operation of the display control apparatus, which are similar to those of the display control apparatus in the first embodiment, will not be elaborated upon.

Based on the current position of the subject vehicle acquired by the positional-information acquiring unit 2 from the position detector 8, a destination or waypoint established by the user, and the map information, the navigation unit 16 calculates a route from the current position of the subject vehicle to the destination or the waypoint. The user can set any destination or any waypoint using the input device 11. The waypoint herein is a user-settable site located from the current position to the destination exclusive. Thus, when the user sets the waypoint, the destination has been already set.

The display device 17 displays information about the route, calculated in the navigation unit 16, information about the guidance on the route, and other kinds of information. To be specific, the display controller 5 controls the input-and-output interface to display the route information, calculated in the navigation unit 16, the route guidance information, and other kinds of information onto the display device 17.

The function of the navigation unit 16 in the display control apparatus 15 is implemented by a processing circuit. That is, the display control apparatus 15 includes a processing circuit for calculating the route from the current position of the subject vehicle acquired by the positional-information acquiring unit 2 from the position detector 8, to the destination or the waypoint. The processing circuit is the processor 13, which executes a program stored in the memory 14, as illustrated in FIG. 3. The other functions of the display control apparatus 15 are similar to those of the display control apparatus in the first embodiment.

The function of the navigation unit 16 in the display control apparatus 15 is implemented by software, firmware, or a combination of software and firmware. As illustrated in FIG. 3, the software or the firmware is written as a program, and stored in the memory 14. The processing circuit reads and then executes the program, stored in the memory 14, to implement the function of the navigation unit 16. That is, the display control apparatus 15 includes the memory 14 for storing a program, which when executed, performs a process step of calculating a route from the current position of the subject vehicle acquired by the positional-information acquiring unit 2 from the position detector 8, to a destination or a waypoint. This program is for a computer to execute the procedure or method of the navigation unit 16. The other functions of the display control apparatus 15 are similar to those of the display control apparatus in the first embodiment.

<Operation>

The following describes the operation of the display control apparatus 15.

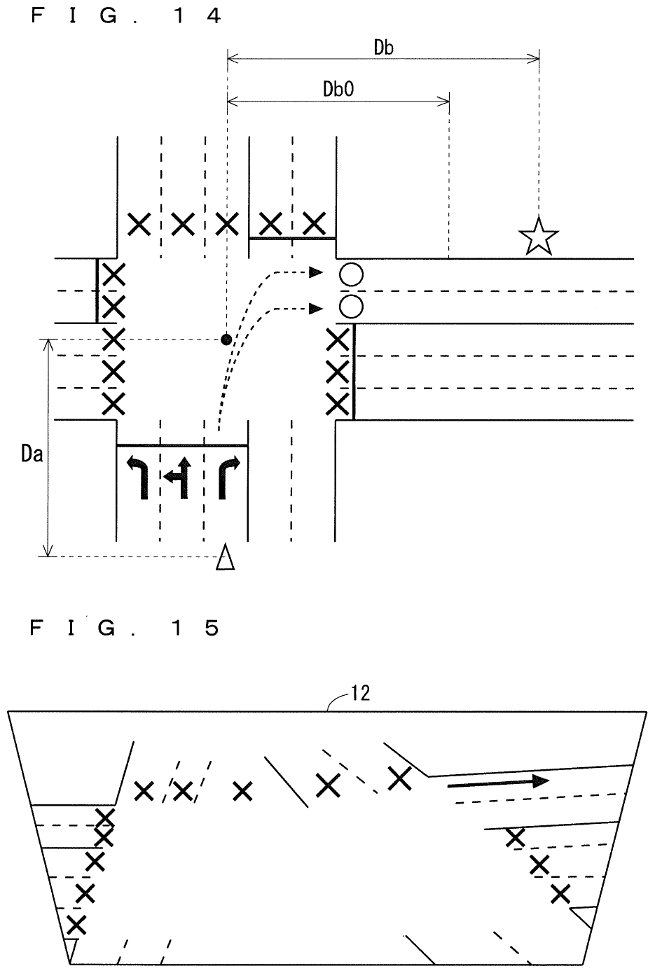

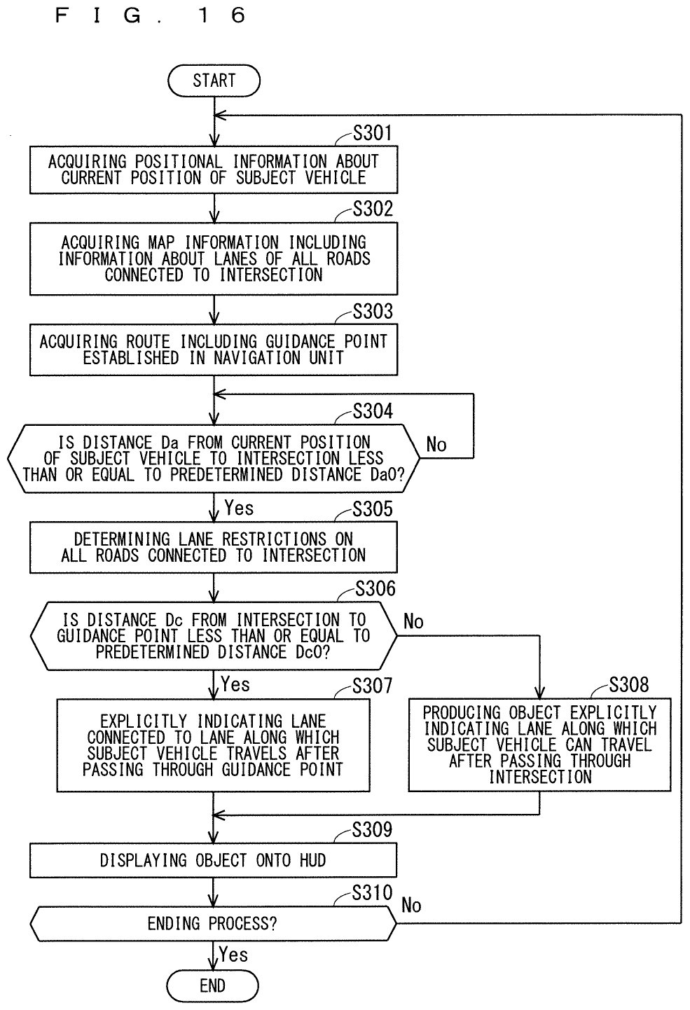

FIG. 12 is a flowchart illustrating one example of the operation of the display control apparatus 15. FIGS. 13 and 14 are each a diagram for describing one example of the operation of the display control apparatus 15. Steps S201, S202, and S210 in FIG. 12, which respectively correspond to steps S101, S102, and step S107 in FIG. 4, will not be elaborated upon. Steps S203 though S209 will be described.

In step S203, the navigation unit 16 calculates a route from the current position of the subject vehicle acquired by the positional-information acquiring unit 2 from the position detector 8, to a destination or a waypoint. Moreover, the lane-restriction determining unit 4 acquires the destination or the waypoint, calculated in the navigation unit 16.

In step S204, based on the positional information about the current position of the subject vehicle acquired by the positional-information acquiring unit 2, and the map information acquired by the map-information acquiring unit 3, the lane-restriction determining unit 4 calculates the distance Da from the current position of the subject vehicle to the intersection, as illustrated in FIGS. 13 and 14. FIGS. 13 and 14 each show a hollow triangle denoting the current position of the subject vehicle, and a black filled-in circle at the intersection denoting the center of the intersection.

The lane-restriction determining unit 4 then determines whether the distance Da is less than or equal to the predetermined distance Da0. If the distance Da is less than or equal to the distance Da0, the process proceeds to step S205. If the distance Da is greater than the distance Da0, the process repeats step S204. It is noted that the user may set the distance Da0 using the input device 11.

In step S205, based on the positional information about the current position of the subject vehicle acquired by the positional-information acquiring unit 2, and the map information acquired by the map-information acquiring unit 3, the lane-restriction determining unit 4 identifies a lane of the road on which the subject vehicle is currently located, and determines lane restrictions on all the roads connected to the intersection into which the subject vehicle makes an entry. That is, when the distance Da is less than or equal to the distance Da0, the lane-restriction determining unit 4 determines the lane restrictions on all the roads connected to the intersection into which the subject vehicle makes an entry.

To be specific, as illustrated in FIGS. 13 and 14, the lane-restriction determining unit 4 identifies that the subject vehicle is located on an exclusive right-turn lane. The lane-restriction determining unit 4 then determines travelable and non-travelable lanes after passing through of the intersection, from the lane on which the subject vehicle is currently located. In the examples in FIGS. 13 and 14, lanes with circles indicate travelable lanes, and lanes with crosses indicate non-travelable lanes.

In step S206, based on the destination or the waypoint, acquired from the navigation unit 16, and the map information acquired by the map-information acquiring unit 3, the lane-restriction determining unit 4 calculates a distance Db from the intersection to the destination or the waypoint, as illustrated in FIGS. 13 and 14. FIGS. 13 and 14 each show a star denoting the destination or the waypoint.

The lane-restriction determining unit 4 then determines whether the distance Db is less than or equal to a predetermined distance Db0. If the distance Db is less than or equal to the distance Db0, the process proceeds to step S207. If the distance Db is greater than the distance Db0, the process proceeds to step S208. It is noted that the user may set the distance Db0 using the input device 11.

In step S207, based on the determination performed by the lane-restriction determining unit 4, the display controller 5 produces an object indicating that the subject vehicle cannot travel after passing through the intersection. This object is produced with respect to the lanes of all the roads connected to the intersection, except at least the road on which the subject vehicle is located. Based on the determination performed by the lane-restriction determining unit 4, and the destination or the waypoint calculated by the navigation unit 16, the display controller 5 also produces an object identifying one of lanes along which the subject vehicle can travel after passing through the intersection, the lane being close to the destination or the waypoint. To be specific, the display controller 5 uses an image from camera 10, including the intersection into which the subject vehicle makes an entry, thus producing an object that is displayed through superimposition on a position corresponding to each lane contained in the image. In the example in FIG. 13, the destination or the waypoint is located on the left side of the road along which the subject vehicle travels after passing through the intersection. Thus, the display controller 5 produces an object identifying one of two lanes of the road along which the subject vehicle travels after passing through the intersection, the lane being close to the destination or the waypoint.

In step S208, based on the determination performed by the lane-restriction determining unit 4, the display controller 5 produces an object indicating that the subject vehicle cannot travel after passing through the intersection. This object is produced for the lanes of all the roads connected to the intersection, except at least the road on which the subject vehicle is located. Based on the determination performed by the lane-restriction determining unit 4, and the destination or the waypoint calculated by the navigation unit 16, the display controller 5 also produces an object identifying a lane along which the subject vehicle can travel after passing through the intersection. In the example in FIG. 14, the display controller 5 produces an object identifying two lanes of the road along which the subject vehicle travels after passing through the intersection.

In step S209, the display controller 5 controls the input-and-output interface 7 to display the object, produced in step S207 or step S208, onto the HUD 12. For the object produced in step S207, on the HUD 12, objects with crosses as illustrated in FIG. 15 for instance are displayed in positions corresponding to the respective lanes; in addition, an object with an arrow as illustrated in FIG. 15 for instance, is displayed in a position corresponding to the lane. The objects with the crosses indicate non-travelable lanes. The object with the arrow indicates a lane close to the destination or the waypoint. For the object produced in step S208, on the HUD 12, objects with arrows (not shown) for instance, are displayed in respective positions corresponding to the two lanes.

The process steps in FIG. 12, although being applied to an instance where the subject vehicle is located on an exclusive right-turn lane, as illustrated in FIGS. 13 and 14, are also applied to an instance where the subject vehicle is located on another lane.

It is noted that FIG. 15 shows, but not limited to, the object with the arrow as the object identifying the lane close to the destination or the waypoint. Any object identifying the lane close to the destination or the waypoint may be displayed.

The foregoing has described, but not limited to, an instance where the road after passing through of the intersection has two lanes, as illustrated in FIGS. 13 and 14. The road after passing through of the intersection may have a plurality of lanes or a single lane.

For audio guidance in accordance with a route calculated by the navigation unit 16, an object may be displayed onto the HUD 12 in conformance with the audio guidance. For instance, an audio guidance message saying, “Please make a right turn at the traffic light 100 m ahead”, may be output, and an object as illustrated in FIG. 15 may be displayed onto the HUD 12. In this case, the input-and-output interface 7 is connected to a speaker (not shown).

As described above, the display control apparatus according to the second embodiment achieves the effect described in the first embodiment. Further, the display control apparatus displays an object identifying one of the lanes along which the subject vehicle can travel after passing through the intersection, the lane being close to the destination or the waypoint. The display control apparatus performs such display when the distance Da from the current position of the subject vehicle to the intersection is less than or equal to the predetermined distance Da0, and when the distance Db from the intersection to the destination or the waypoint is less than or equal to the predetermined distance Db0. Consequently, the display control apparatus allows the driver to easily recognize the lane close to the destination or the waypoint. That is, the driver can drive along an arrow denoted by a dashed line in FIG. 13, and can arrive at the destination or the waypoint without changing lanes after passing through the intersection.

The driver can change lanes between the intersection and the destination or the waypoint, when the distance Da from the current position of the subject vehicle to the intersection is less than or equal to the predetermined distance Da0, and when the distance Db from the intersection to the destination or the waypoint is greater than the predetermined distance Db0. In such a case, the display control apparatus according to the second embodiment displays the object identifying the lane along which the subject vehicle can travel after passing through the intersection. Consequently, the display control apparatus allows the driver to travel while selecting any lane, when there are a plurality of travelable lanes.

### Third Embodiment

The configuration of a display control apparatus according a third embodiment of the present invention is the same as that of the display control apparatus 15 according to the second embodiment, illustrated in FIG. 11. The following description equates the display control apparatus according to the third embodiment with the display control apparatus 15 illustrated in FIG. 11.

<Operation>

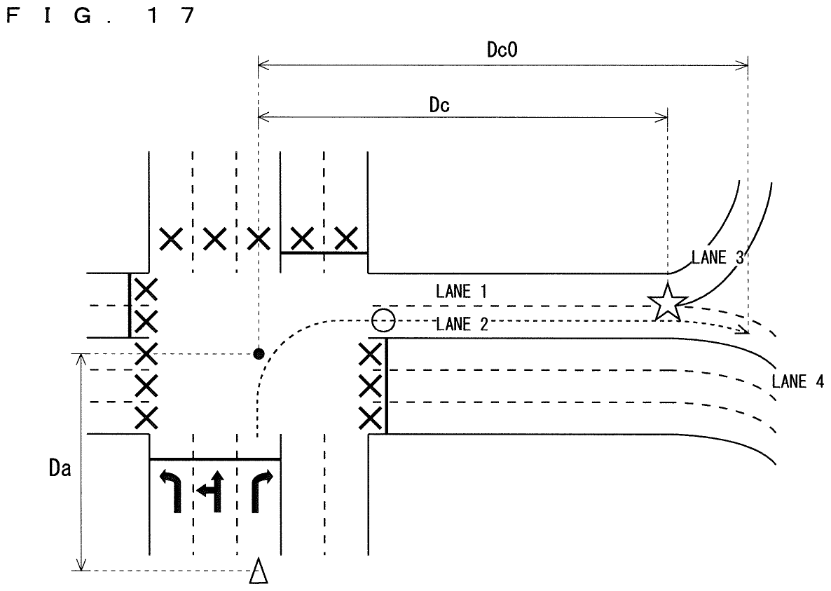

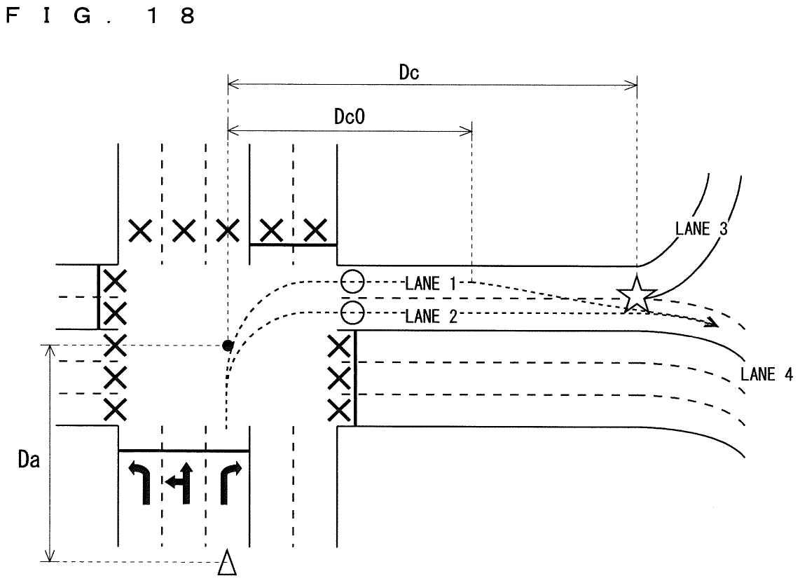

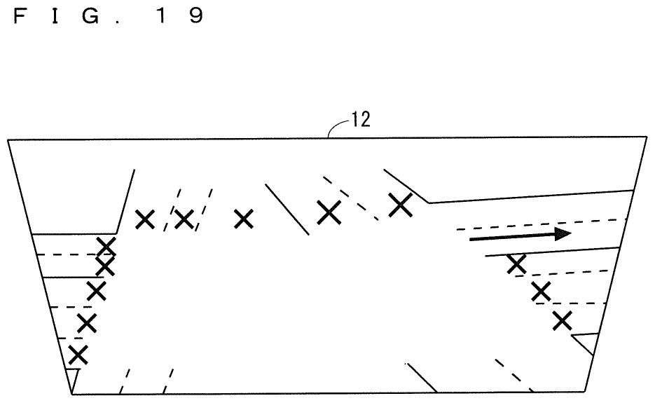

FIG. 16 is a flowchart illustrating one example of the operation of the display control apparatus 15 according to the third embodiment. FIGS. 17 and 18 are each a diagram for describing one example of the operation of the display control apparatus 15 according to the third embodiment. Steps S301, S302, and S310 in FIG. 16, which respectively correspond to steps S201, S202, and S210 in FIG. 12, will not be elaborated upon. Steps S303 through S309 will be described.

In step S303, the navigation unit 16 calculates a route from the current position of the subject vehicle acquired by the positional-information acquiring unit 2 from the position detector 8, to a destination or a waypoint. The lane-restriction determining unit 4 then acquires the route including a guidance point, calculated in the navigation unit 16. The guidance point is a site located between the current position and the destination, and is a fork in a road for instance.

In step S304, based on the information about the current position of the subject vehicle acquired by the positional-information acquiring unit 2, and the map information acquired by the map-information acquiring unit 3, the lane-restriction determining unit 4 calculates the distance Da from the current position of the subject vehicle to the intersection, as illustrated in FIGS. 17 and 18. FIGS. 17 and 18 each show a hollow triangle denoting the current position of the subject vehicle, and a black filled-in circle at the intersection denoting the center of the intersection.

The lane-restriction determining unit 4 then determines whether the distance Da is less than or equal to the predetermined distance Da0. If the distance Da is less than or equal to the distance Da0, the process proceeds to step S305. If the distance Da is greater than the distance Da0, the process repeats step S304. It is noted that the user may set the distance Da0 using the input device 11.

In step S305, based on the information about the current position of the subject vehicle acquired by the positional-information acquiring unit 2, and the map information acquired by the map-information acquiring unit 3, the lane-restriction determining unit 4 identifies a lane of the road on which the subject vehicle is currently located, and determines lane restrictions on all the roads connected to the intersection into which the subject vehicle makes an entry. That is, when the distance Da is less than or equal to the distance Da0, the lane-restriction determining unit 4 determines the lane restrictions on all the roads connected to the intersection into which the subject vehicle makes an entry.

To be specific, as illustrated in FIGS. 17 and 18, the lane-restriction determining unit 4 identifies that the subject vehicle is located on an exclusive right-turn lane. The lane-restriction determining unit 4 then determines travelable and non-travelable lanes after passing through of the intersection, from the lane on which the subject vehicle is currently located. In the examples in FIGS. 17 and 18, lanes with circles indicate travelable lane, and lanes with crosses indicate non-travelable lanes.

In step S306, based on the guidance point, acquired from the navigation unit 16, and the map information acquired by the map-information acquiring unit 3, the lane-restriction determining unit 4 calculates a distance Dc from the intersection to the guidance point, as illustrated in FIGS. 17 and 18. FIGS. 17 and 18 each show a star denoting the guidance point.

The lane-restriction determining unit 4 then determines whether the distance Dc is less than or equal to a predetermined distance Dc0. If the distance Dc is less than or equal to the distance Dc0, the process proceeds to step S307. If the distance Dc is greater than the distance Dc0, the process proceeds to step S308. It is noted that the user may set the distance Dc0 using the input device 11.

In step S307, based on the determination performed by the lane-restriction determining unit 4, the display controller 5 produces an object indicating that the subject vehicle cannot travel after passing through the intersection. This object is produced with respect to the lanes of all the roads connected to the intersection, except at least the road on which the subject vehicle is located. Further, based on the determination performed by the lane-restriction determining unit 4, and the route including the guidance point calculated by the navigation unit 16, the display controller 5 produces an object identifying one of lanes along which the subject vehicle can travel after passing through the intersection, the lane being connected to a lane along which the subject vehicle travels after passing through the guidance point.

To be specific, the display controller 5 uses an image from the camera 10 including the intersection into which the subject vehicle makes an entry, thus producing objects that are displayed through superimposition on positions corresponding to the respective lanes contained in the image. In the example in FIG. 17, the route calculated in the navigation unit 16 includes a lane 4, along which the subject vehicle travels after passing through the guidance point. In addition, between lanes 1 and 2 after passing through of the intersection, the lane 2 is connected to the lane 4 after passing through of the guidance point. Accordingly, the display controller 5 produces an object identifying the lane 2 between the lanes 1 and 2 after passing through of the intersection.

In step S308, based on the determination performed by the lane-restriction determining unit 4, the display controller 5 produces an object indicating that the subject vehicle cannot travel after passing through the intersection. This object is produced with respect to the lanes of all the roads connected to the intersection, except at least the road on which the subject vehicle is located. Further, based on the determination performed by the lane-restriction determining unit 4, and the route including the guidance point calculated by the navigation unit 16, the display controller 5 produces an object identifying a lane along which the subject vehicle can travel after passing through the intersection. In the example in FIG. 18, the display controller 5 produces an object identifying two lanes of the road along which the subject vehicle travels after passing through the intersection.

In step S309, the display controller 5 controls the input-and-output interface 7 to display the object, produced in step S307 or step S308, onto the HUD 12. For the object produced in step S307, on the HUD 12, objects with crosses as illustrated in FIG. 19 for instance, are displayed in positions corresponding to the respective lanes; in addition, an object with an arrow as illustrated in FIG. 19 for instance, is displayed in a position corresponding to the lane. The objects with the crosses indicate travelable lanes. The object with the arrow indicates a lane connected to the lane along which the subject vehicle travels after passing through the guidance point. For the object produced in step S308, on the HUD 12, objects with arrows (not shown) are displayed in respective positions corresponding to the two lanes.

The process steps in FIG. 16, although being applied to an instance where the subject vehicle is located on an exclusive right-turn lane in the above example in FIGS. 17 and 18, are also applied to an instance where the subject vehicle is located on another lane.

It is noted that FIG. 19 shows, but not limited to, that the object with the arrow is displayed as the object identifying the lane connected to the lane along which the subject vehicle travels after passing through the guidance point. Any object may be displayed that identifies the lane connected to the lane along which the subject vehicle travels after passing through the guidance point.

The foregoing has described, but not limited to, an instance where the road after passing through of the intersection has two lanes, as illustrated in FIGS. 17 and 18. The road after passing through of the intersection may have a plurality of lanes or a single lane.

As described above, the display control apparatus according to the third embodiment achieves the effect described in the first embodiment. Further, the display control apparatus displays the object identifying one of the lanes along which the subject vehicle can travel after passing through the intersection, the lane being connected to the lane along which the subject vehicle travels after passing through the guidance point. The display control apparatus performs such display when the distance Da from the current position of the subject vehicle to the intersection is less than or equal to the predetermined distance Da0, and when the distance Dc from the intersection to the guidance point is less than or equal to the predetermined distance Dc0. Consequently, the display control apparatus allows the driver to easily recognize the lane connected to the lane along which the subject vehicle travels after passing through the guidance point. That is, the driver can drive along an arrow denoted by a dashed line in FIG. 17, and can travel along a lane after passing through of the guidance point, without changing lanes after passing through the intersection.

The driver can change lanes between the intersection and the guidance point, when the distance Da from the current position of the subject vehicle to the intersection is less than or equal to the predetermined distance Da0, and when the distance Dc from the intersection to the guidance point is greater than the predetermined distance Dc0. In such a case, the display control apparatus according to the third embodiment displays the object identifying the lane along which the subject vehicle can travel after passing through the intersection. Consequently, the display control apparatus allows the driver to travel while selecting any lane, when there are a plurality of travelable lanes.

### Fourth Embodiment

The configuration of a display control apparatus according a fourth embodiment of the present invention is the same as that of the display control apparatus 15 according to the second embodiment, illustrated in FIG. 11. The following description equates the display control apparatus according to the fourth embodiment with the display control apparatus 15, illustrated in FIG. 11.

<Operation>

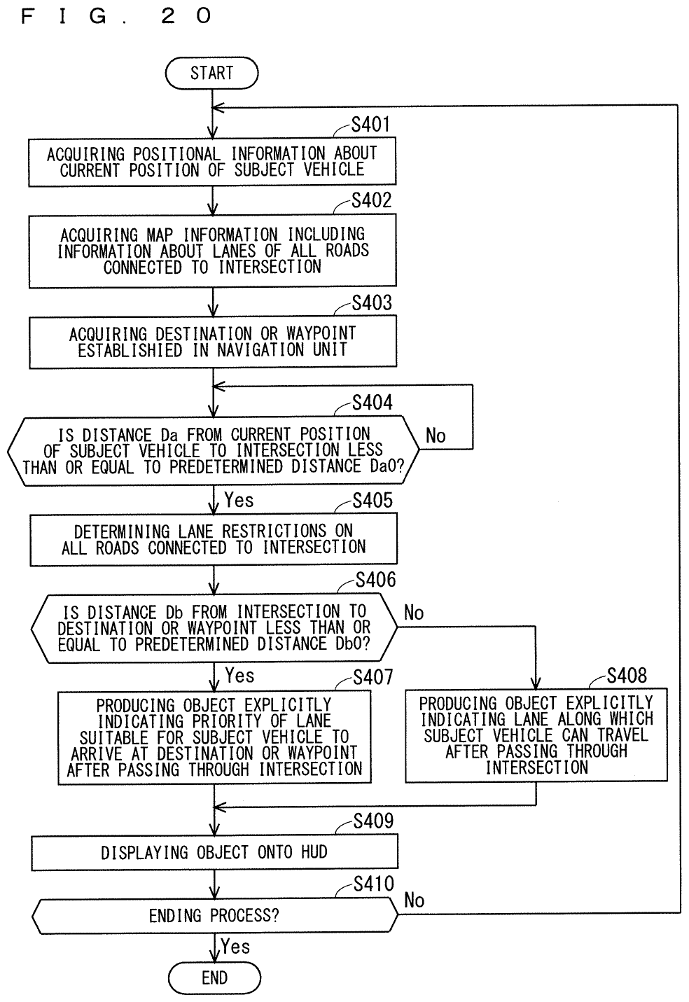

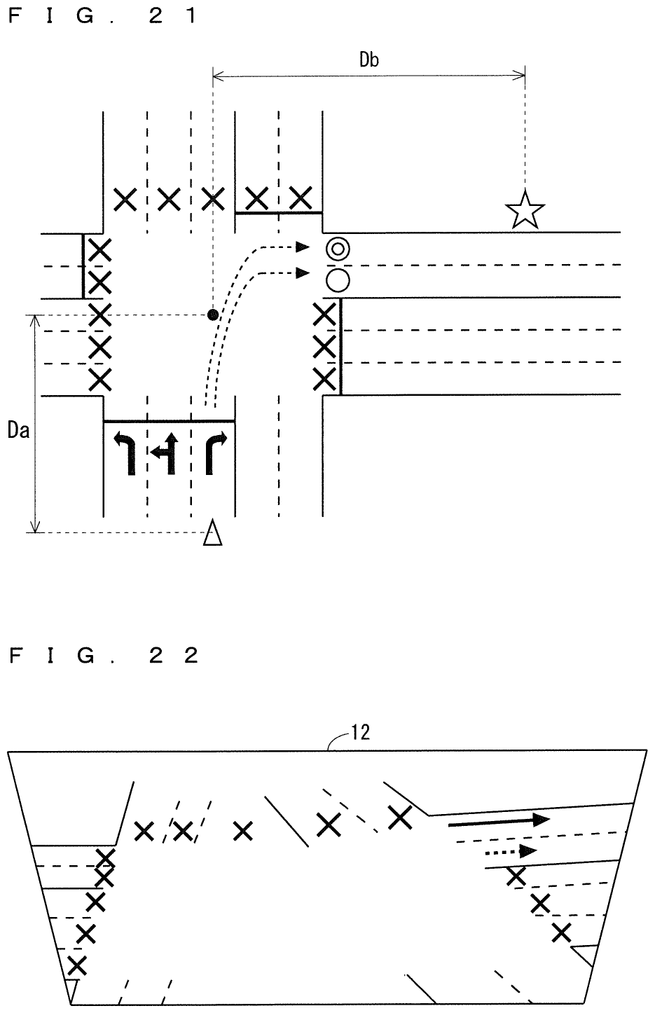

FIG. 20 is a flowchart illustrating one example of the operation of the display control apparatus 15 according to the fourth embodiment. FIG. 21 is a diagram for describing one example of the operation of the display control apparatus 15 according to the fourth embodiment. Steps S401 through S406, and step S410 in FIG. 20, which respectively correspond to steps S201 through S206, and step S210 in FIG. 12, will not be elaborated upon. Steps S407, S408, and S409 will be described.

In step S407, based on the determination performed by the lane-restriction determining unit 4, the display controller 5 produces an object indicating that the subject vehicle cannot travel after passing through the intersection. This object is produced with respect to the lanes of all the roads connected to the intersection, except at least the road on which the subject vehicle is located. Further, based on the determination performed by the lane-restriction determining unit 4, and the destination or the waypoint calculated by the navigation unit 16, the display controller 5 produces an object indicating that one of a plurality of lanes along which the subject vehicle can travel after passing through the intersection has high priority, the lane being close to the destination or the waypoint.

To be specific, the display controller 5 uses an image from the camera 10 including the intersection into which the subject vehicle makes an entry, thus producing objects that are displayed through superimposition on positions corresponding to the respective lanes contained in the image. In the example in FIG. 21, the destination or the waypoint is located on the left side of the road on which the subject vehicle is located after passing through the intersection. Accordingly, the display controller 5 produces an object indicating that one of two lanes of the road along which the subject vehicle travels after passing through the intersection has high priority, the lane being close to the destination or the waypoint. FIG. 21 shows a double circle having higher priority than a single circle.

In step S408, based on the determination performed by the lane-restriction determining unit 4, the display controller 5 produces an object indicating that the subject vehicle cannot travel after passing through the intersection. This object is produced with respect to the lanes of all the roads connected to the intersection, except at least the road on which the subject vehicle is located. Based on the determination performed by the lane-restriction determining unit 4, and the destination or the waypoint calculated by the navigation unit 16, the display controller 5 also produces an object identifying a lane along which the subject vehicle can travel after passing through the intersection. As illustrated in FIG. 14 for instance, the display controller 5 produces an object identifying two lanes of the road along which the subject vehicle travels after passing through the intersection.

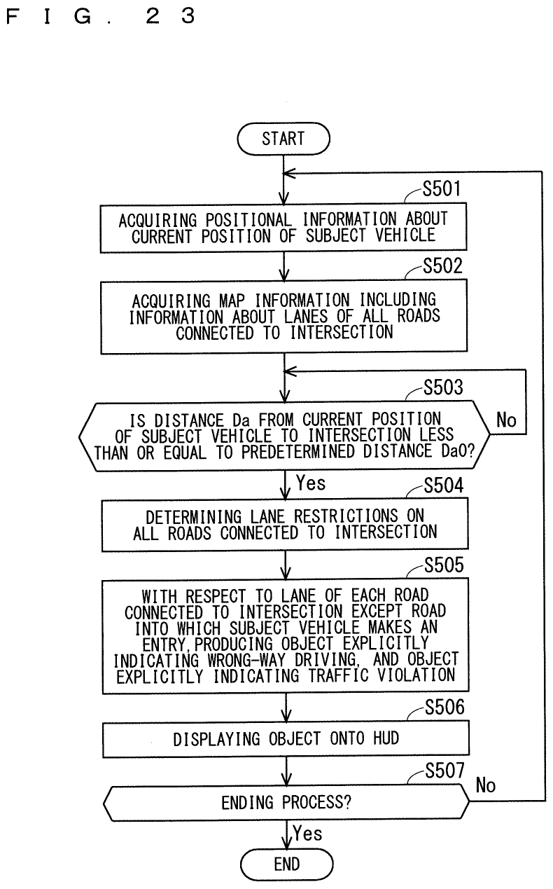

In step S409, the display controller 5 controls the input-and-output interface 7 to display the object, produced in step S407 or step S408, onto the HUD 12. For the object produced in step S407, on the HUD 22, objects with crosses as illustrated in FIG. 22 for instance, are displayed in positions corresponding to the respective lanes; in addition, an object with an arrow denoted by a solid line, and an object with an arrow denoted by a dashed line, as illustrated in FIG. 22 for instance, are displayed in positions corresponding to the respective lanes. The objects with the crosses indicate travelable lanes. The object with the solid-line arrow indicates that this object is closer to the destination or the waypoint than the object with the dashed-line arrow. That is, the object with the solid-line arrow indicates that this object has higher priority than the object with the dashed-line arrow. For the object produced in step S408, on the HUD 12, objects (not shown) with arrows denoted by solid lines for instance, are displayed in positions corresponding to the respective two lanes.

The process steps in FIG. 20, although being applied to an instance where the subject vehicle is located on an exclusive right-turn lane in the above example in FIG. 21, are also applied to an instance where the subject vehicle is located on another lane.

It is noted that FIG. 22 shows, but not limited to, the object with the solid-line arrow and the object with the dashed-line arrow, both of which are used to indicate priority. Any object indicating priority may be displayed.

As described above, the display control apparatus according to the fourth embodiment achieves the effect described in the second embodiment. Further, the display control apparatus displays the object indicating that one of the lanes along which the subject vehicle can travel after passing through the intersection has high priority, the lane being close to the destination or the waypoint. The display control apparatus performs such display when the distance Da from the current position of the subject vehicle to the intersection is less than or equal to the predetermined distance Da0, and when the distance Db from the intersection to the destination or the waypoint is less than or equal to the predetermined distance Db0. Consequently, the display control apparatus allows the driver to easily recognize the lane close to the destination or the waypoint. As a result, the driver can arrive at the destination or the waypoint without changing lanes after passing through the intersection.

Further, the driver can change lanes between the intersection and the destination or the waypoint, when the distance Da from the current position of the subject vehicle to the intersection is less than or equal to the predetermined distance Da0, and when the distance Db from the intersection to the destination or the waypoint is greater than the predetermined distance Db0. In such a case, the display control apparatus according to the fourth embodiment displays the object identifying the lane along which the subject vehicle can travel after passing through the intersection. Consequently, the display control apparatus allows the driver to travel while selecting any lane from among a plurality of travelable lanes.

The foregoing has described, but not limited to, in the second embodiment, displaying of the object indicating that the lane close to the destination or the waypoint has high priority. For instance, in the third embodiment, the object indicating that one of the lanes along which the subject vehicle can travel after passing through the intersection has high priority, the lane being connected to a lane along which the subject vehicle travels after passing through the guidance point. Such a case still achieves effects similar to the aforementioned effects.

### Fifth Embodiment

The configuration of a display control apparatus according a fifth embodiment of the present invention is the same as that of the display control apparatus 6 according to the first embodiment, illustrated in FIG. 2. The following description equates the display control apparatus according to the fifth embodiment with the display control apparatus 6 illustrated in FIG. 2.

<Operation>

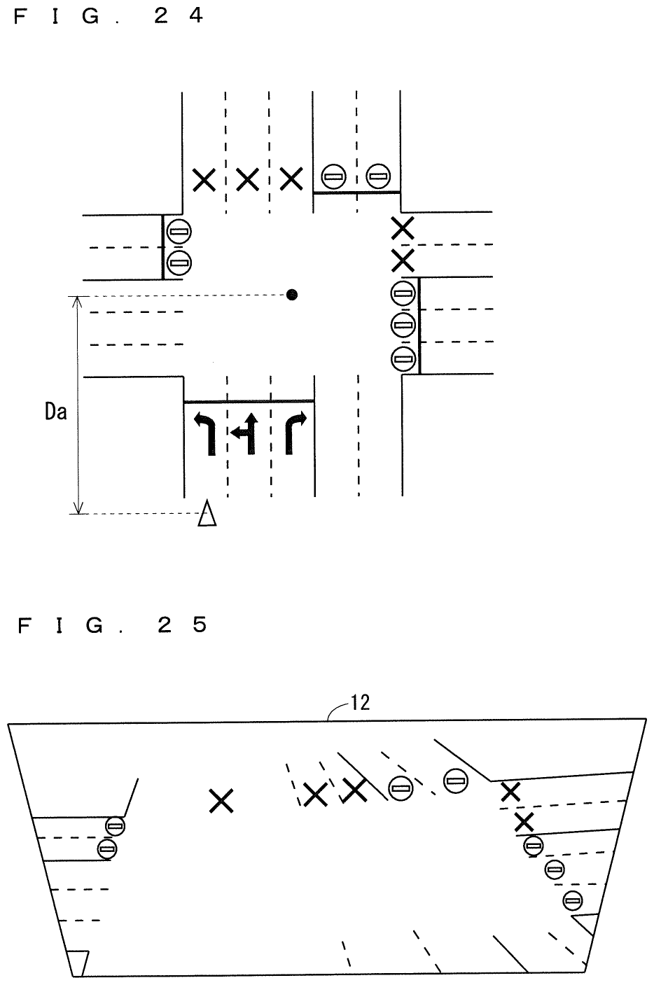

FIG. 23 is a flowchart illustrating one example of the operation of the display control apparatus 6 according to the fifth embodiment. FIG. 24 is a diagram for describing one example of the operation of the display control apparatus 6 according to the fifth embodiment. Steps S501 through S504, and step S507 in FIG. 23, which respectively correspond to steps S101 through S104, and step S107 in FIG. 4, will not be elaborated upon. Steps S505 and S506 will be described.

In step S505, based on the determination performed by the lane-restriction determining unit 4, the display controller 5 produces an object explicitly indicating wrong-way driving, and an object explicitly indicating a traffic violation. These objects are produced with respect to the lanes of the individual roads connected to the intersection, except the road into which the subject vehicle makes an entry. An example of the traffic violation is, in FIG. 24, the fact that although the subject vehicle is located on an exclusive left-turn lane, it travels straight ahead or makes a right turn. To be specific, the display controller 5 uses an image from the camera 10 including the intersection into which the subject vehicle makes an entry, thus producing objects that are displayed through superimposition on positions corresponding to the respective lanes contained in the image.

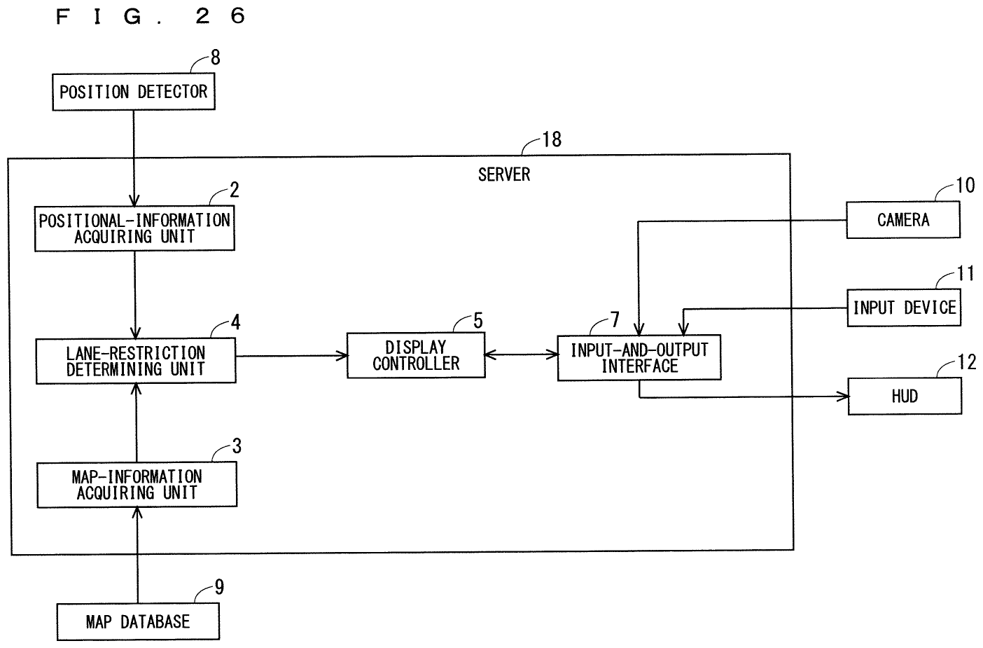

In step S506, the display controller 5 controls the input-and-output interface 7 to display the objects, produced in step S505, onto the HUD 12. On the HUD 12, objects with crosses and objects with “Do Not Enter” marks as illustrated in FIG. 25 for instance, are displayed in positions corresponding to the respective lanes. The objects with the crosses indicate that the driver will violate traffic rules if entering these lanes. The objects with the “Do Not Enter” marks indicate that the driver will drive the wrong way if entering these lanes. It is noted that such a “Do Not Enter” mark, which is different from country to county, is not limited to that illustrated in FIGS. 24 and 25; any mark is used that indicates the subject vehicle will drive the wrong way if entering the lane.

As described above, the display control apparatus according to the fifth embodiment achieves the effect described in the first embodiment. Further, the display control apparatus displays the object explicitly indicating wrong-way driving and the object explicitly indicating a traffic violation. Consequently, the display control apparatus allows the driver to easily recognize wrong-way driving or a traffic violation for each lane.

Although the foregoing has described an instance where, in the first embodiment, the object explicitly indicating wrong-way driving and the object explicitly indicating a traffic violation are displayed, the foregoing is applicable to the second to fourth embodiments.

The aforementioned display control apparatus can be used not only in a vehicle-mounted navigator (i.e., car navigation device), but also in a navigator formed as a system in appropriate combination with, for instance, a vehicle-mountable portable navigation device (PND) and with a server placed outside a vehicle. Alternatively, the display control apparatus can be used in a device other than such a navigation device. In this case, the functions or components of the display control apparatus are distributed, for placement, to respective functions that constitute the aforementioned system.

To be specific, the functions of the display control apparatus can be placed on a server, for instance. Take FIG. 26 for example. A display control system can be formed that includes a user interface and a server 18. The user interface includes the position detector 8, the camera 10, the input device 11, and the HUD 12. The server 18 includes the positional-information acquiring unit 2, the map-information acquiring unit 3, the lane-restriction determining unit 4, the display controller 5, and the input-and-output interface 7. The same holds true for the display control apparatus 15, illustrated in FIG. 11. It is noted that the map database 9 may be separated from the server 18, or may be included in the server 18.

The above configuration, in which the functions of the display control apparatus are distributed, for placement, to the respective functions that constitute the system, still achieves effects similar to those described in the foregoing embodiments.

Software that executes the operation described in the foregoing embodiments may be incorporated to a server, for instance. The server, when executing this software, implements controlling of display. A method for controlling display includes the following: acquiring positional information about the current position of a subject vehicle; acquiring, as information about an intersection, map information including information about lanes of all roads connected to the intersection; based on the acquired positional information and the acquired map information, determining lane restrictions on the lanes of all the roads connected to the intersection into which the subject vehicle makes an entry; based on the determination, controlling the display of whether the subject vehicle is capable of travelling after passing through the intersection. This display is performed with respect to the lanes of all the roads connected to the intersection, except at least the road on which the subject vehicle is located.

Incorporating the software, which executes the operation described in the foregoing embodiments, to the server for operation achieves effects similar to those described in the aforementioned embodiments.

It is noted that in the present invention, the individual embodiments can be freely combined, or can be modified and omitted as appropriate, within the scope of the invention.

While the invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

1 display control apparatus, 2 positional-information acquiring unit, 3 map-information acquiring unit, 4 lane-restriction determining unit, 5 display controller, 6 display control apparatus, 7 input-and-output interface, 8 position detector, 9 map database, 10 camera, 11 input device, 12 HUD, 13 processor, 14 memory, 15 display control apparatus, 16 navigation unit, 17 display device, 18 server.

1. A display control apparatus comprising:
a processor to execute a program; and
a memory to store the program which, when executed by the processor, performs processes of,
acquiring positional information about a current position of a subject vehicle;
acquiring, as information about an intersection, map information including information about lanes of all roads connected to the intersection;
based on the acquired positional information and the acquired map information, identifying the lane of the road on which the subject vehicle is currently located, and determining restrictions on the lanes of all the roads connected to the intersection into which the subject vehicle makes an entry; and
based on the determination, controlling display of an object indicating a non-travelable lane for the subject vehicle that has passed through the intersection onto a head-up display through superimposition on a position corresponding to the non-travelable lane, the object being displayed with respect to the lanes of all the roads connected to the intersection, except at least the road on which the subject vehicle is located.

2. The display control apparatus according to claim 1, wherein the determination is performed when a distance between the acquired current position of the subject vehicle and the intersection into which the subject vehicle makes an entry is less than or equal to a predetermined distance.

3. The display control apparatus according to claim 1, wherein the program, when executed by the processor, further performs a process of calculating a route from the acquired current position of the subject vehicle to a destination or a waypoint,
wherein the controlling comprises controlling, based on the determination and the calculated destination or waypoint, display of an object identifying one of lanes of the road along which the subject vehicle travels after passing through the intersection, the one lane being close to the destination or the waypoint.

4. The display control apparatus according to claim 3, wherein the determination is performed when a distance between the acquired current position of the subject vehicle and the intersection into which the subject vehicle makes an entry is less than or equal to a predetermined distance, and when a distance between the intersection and the destination or the waypoint is less than or equal to a predetermined distance.

5. The display control apparatus according to claim 3, wherein the controlling comprises controlling display of an object indicating that one of a plurality of lanes of the road along which the subject vehicle travels after passing through the intersection has high priority, the one lane being close to the destination or the waypoint.

6. The display control apparatus according to claim 1, wherein the program, when executed by the processor, further performs a process of calculating a route including a guidance point that is located between the acquired current position of the subject vehicle and a destination, and
the controlling comprises controlling, based on the determination and the calculated route including the guidance point, display of an object identifying one of lanes of the road along which the subject vehicle travels after passing through the intersection, the one lane being connected to a lane along which the subject vehicle travels after passing through the guidance point.

7. The display control apparatus according to claim 6, wherein the determination is performed when a distance between the acquired current position of the subject vehicle and the intersection into which the subject vehicle makes an entry is less than or equal to a predetermined distance, and when a distance between the intersection and the guidance point is less than or equal to a predetermined distance.

8. The display control apparatus according to claim 6, wherein the controlling comprises controlling display of an object indicating that one of a plurality of lanes of the road along which the subject vehicle travels after passing through the intersection has high priority, the one lane being connected to the lane along which the subject vehicle travels after passing through the guidance point.

9. The display control apparatus according to claim 1, wherein the controlling comprises displaying an object indicating that a wrong-way driving lane for the subject vehicle to travel after passing through of the intersection, and another object indicating a traffic-violation lane for the subject vehicle to travel after passing of through the intersection.

10. A method for controlling display, comprising:
acquiring positional information about a current position of a subject vehicle;
acquiring, as information about an intersection, map information including information about lanes of all roads connected to the intersection;
based on the acquired positional information and the acquired map information, identifying the lane of the road on which the subject vehicle is currently located, and determining lane restrictions on the lanes of all the roads connected to the intersection into which the subject vehicle makes an entry; and
based on the determination, controlling display of an object indicating a non-travelable lane for the subject vehicle that has passed through the intersection onto a head-up display through superimposition on a position corresponding to the non-travelable lane, the object being displayed with respect to the lanes of all the roads connected to the intersection, except at least the road on which the subject vehicle is located.
